(19) United States
(12) Patent Application Publication
(10) Pub. No.: US 2006/0277149 A1
(43) Pub. Date: Dec. 7, 2006

(54) ELECTRONIC CLEARING SYSTEM, ELECTRONIC CLEARING SERVER, ELECTRONIC CLEARING TERMINAL, AND COMPUTER PROGRAM

(75) Inventors: Kenji Kouno, Tokyo (JP); Hirofumi Nakagawa, Kanagawa (JP); Haruhiko Kasuya, Tokyo (JP); Takashi Hanazato, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/420,145

(22) Filed: May 24, 2006

(30) Foreign Application Priority Data
Jun. 3, 2005 (JP) 2005-164590

(51) Int. Cl. G06Q 40/00

(52) U.S. Cl. 705/42; 705/45

(57) ABSTRACT

Disclosed is an electronic clearing system which electronically processes and clears a valuable instrument including a substrate and prescribed information printed on the substrate. The system has: an electronic clearing server; a payor's bank terminal which is installed in a payor's bank, and originally issues the valuable instrument; a payee's bank terminal which is installed in a payee's bank and to which the valuable instrument is presented; and an electronic network which electronically connects the electronic clearing server with each of the payor's bank terminal and the payee's bank terminal. In this system: the valuable instrument further includes code information printed on the substrate, the code information being obtained by converting substrate identification information, which differentiates each substrate from other substrates, into a specific format; the payor's bank terminal transmits the substrate identification information and the code information to the electronic clearing server; the electronic clearing server manages the substrate identification information and the code information with the substrate identification information and the code information associated with each other; the payee's bank terminal obtains the substrate identification information and the code information from the valuable instrument presented to the payee's bank, and transmits the substrate identification information and the code information to the electronic clearing server; and the electronic clearing server determines whether the valuable instrument presented to the payee's bank terminal is valid by comparing the substrate identification information and the code information as managed by the electronic clearing server, with the substrate identification information and the code information as transmitted from the payee's bank terminal.

### CROSS REFERENCES TO RELATED APPLICATIONS

The present invention contains subject matter related to Japanese Patent Application No. 2005-164590 filed in the Japanese Patent Office on Jun. 3, 2005, the entire contents of which being incorporated herein by reference.

### BACKGROUND OF THE INVENTION

1. Field of the Invention

The present invention relates to an electronic clearing system, an electronic clearing server, an electronic clearing terminal, and a computer program, and particularly to an electronic clearing system, an electronic clearing server, an electronic clearing terminal, and a computer program, for implementing check truncation.

2. Description of Related Art

With the development in electronics, computerization has been recently dramatically advanced in the field of business transactions. In place of the conventional paper-based clearing process, a paperless clearing process is becoming feasible, with development of relevant laws accelerated. In such a situation, there is an attempt called check truncation, which is computerization of processing of checks and notes, which is of significant in banking services. According to the check truncation, originally-issued checks or notes are not physically transported between banks, that is, there is realized a clearing process where when an original of a check or a note in the form of a paper sheet presented to a bank of first deposit, the original check or note is not transferred to a payor bank, but is kept at the bank of first deposit. Electronic data representative of an image of a face of the original check or note is transmitted by way of a communication means from the bank of first deposit to the payor bank, along with various other data including data representative of an account number of a drawer or a maker and an amount of the check or note. The check truncation is disclosed in “Shukan Kinyu Zaisei Jijo” (Weekly Financial & Fiscal Circumstances), Dec. 10, 2001 issue, for instance.

### SUMMARY OF THE INVENTION

As described above, the clearing process of the check truncation is advantageous over the paper-based clearing process, in that the cost entailed by the physical transportation of the originals is omitted and the inefficiency due to actual clearing actions implemented at a bankers' association is overcome. However, the check truncation process costs high since security should be ensured against frauds such as fraudulent replication or duplication and alteration of a check or a note, spoofing, in a system for converting checks or notes into electronic data. One of the causes of the high cost is a dedicated line which is essential to ensure a sufficient level of security in the data transfer. Thus, the cost cannot be much reduced actually, by the computerization.

This invention has been developed in view of the above-described situations, and provides an electronic clearing system, an electronic clearing server, an electronic clearing terminal, and a computer program for implementing the check truncation, that are novel and improved to be capable of easily preventing fraudulent replication or duplication of checks and notes, while ensuring security at low cost.

According to a first aspect of the invention, there is provided an electronic clearing system which electronically processes and clears a valuable instrument including a substrate and prescribed information printed on the substrate. The electronic clearing system includes: an electronic clearing server; a payor's bank terminal which is installed in a payor's bank, and originally issues the valuable instrument; a payee's bank terminal which is installed in a payee's bank and to which the valuable instrument is presented; and an electronic network which electronically connects the electronic clearing server with each of the payor's bank terminal and the payee's bank terminal. The valuable instrument further includes code information printed on the substrate, which code information is obtained by converting substrate identification information, which differentiates each substrate from other substrates, into a specific format.

The payor's bank terminal transmits the substrate identification information and the code information to the electronic clearing server. The electronic clearing server manages the substrate identification information and the code information with the substrate identification information and the code information associated with each other. The payee's bank terminal obtains the substrate identification information and the code information from the valuable instrument presented to the payee's bank, and transmits the substrate identification information and the code information to the electronic clearing server. The electronic clearing server determines whether the valuable instrument presented to the payee's bank terminal is valid, that is, whether the presented valuable instrument is a replicate or duplicate, by comparing the substrate identification information and the code information as managed by the electronic clearing server, with the substrate identification information and the code information as transmitted from the payee's bank terminal.

In this system, when the valuable instrument is replicated or duplicated, the code information can be copied, but the substrate identification information cannot be copied since the substrate of the obtained replicate or duplicate is not identical with the substrate of the original valuable instrument. Hence, the substrate identification information and the code information are obtained from the valuable instrument presented to the payee's bank, and transmitted to the electronic clearing server, which then verifies the validity of the presented valuable instrument, namely, determines whether the presented valuable instrument is the original or a replicate or duplicate thereof. In this way, fraudulent replication or duplication of a valuable instrument is easily preventable when implementing the check truncation. The substrate identification information and the code information include merely information for warranting the originality of the valuable instrument, and do not include information related to substantive contents of the valuable instrument. Thus, a dedicated line or the like is not necessary for transmission of information through an electronic network, thereby reducing the cost of introducing the system.

Since information related to a plurality of the valuable instruments can be managed in a centralized manner by the electronic clearing server, it is possible to make efficient use of the information. For instance, data mining is possible.

An example of the substrate identification information is information obtained from a textural pattern of the substrate, namely, a feature quantity of the textural pattern. That is, from a predetermined area in the substrate, information or a feature quantity based on physical properties of the substrate can be obtained. For instance, the feature quantity can be extracted from an image of the substrate by using a low-pass filter. The information obtained from the textural pattern, i.e., the feature quantity, shows a characteristic unique to each substrate. Thus, the information or the feature quantity obtained from the textural pattern is able to warrant the originality of the substrate, and can be used as the substrate identification information.

By employing the textural pattern as the substrate identification information, it is made possible to use the conventional valuable instrument in the check truncation process without much revising the conventional valuable instrument, while the cost required by electronically processing information for warranting the originality is greatly reduced. Thus, the check truncation can be implemented without requiring much cost.

Another example of the substrate identification information is information recorded in an IC tag that the substrate has. Since an IC tag can record a large amount of information, the information for warranting the originality of each substrate can be recorded in the IC tag.

The specific format may be a two-dimensional barcode. That is, the code information may be obtained by converting the substrate identification information into a two-dimensional barcode, which is then printed on the substrate. A two-dimensional barcode enables recording and utilization of data of figures, letters and others in an amount of about 2000 bytes at a maximum. Thus, even when an amount of information presented by the substrate identification information is relatively large, the two-dimensional barcode enables to associate the substrate identification information and the code information. The association may be made in one-to-one correspondence, for instance.

Characterized as described above, the substrate identification information and the code information are associable with each other in one-to-one correspondence. However, fraudulent replication or duplication of the valuable instrument can be prevented even when the substrate identification information and the code information do not correspond to each other strictly in one-one relation, and it suffices that the substrate identification information and the code information correspond to each other substantially in one-one relation. When considering the case of human fingerprint or DNA by way of analogy, it can be said that although stochastically there is a possibility that fingerprints or DNAs of two persons are erroneously determined to be a fingerprint or DNA of a single person, the possibility that such an erroneous determination is made in identification of human beings is negligibly low. Similarly, in the present invention, it suffices that the correspondence between the substrate identification information and the code information is substantially one-to-one, in terms of prevention of fraudulent duplication of the valuable instrument, or of determination on the validity of the presented valuable instrument.

The electronic clearing server may have a dishonor database for managing information on a dishonored valuable instrument, make the determination on the validity of the valuable instrument presented to the payee's bank terminal, by using the dishonor database, and add information on the presented valuable instrument to the dishonor database when the validity of the presented valuable instrument is not verified. This electronic clearing server can manage information on dishonored valuable instruments in a centralized manner, thereby enabling to make efficient use of the information such as data mining.

The electronic network that electronically connects the electronic clearing server with each of the payor's bank terminal and the payee's bank terminal may be a VPN (Virtual Private Network). The substrate identification information and the code information include only information for warranting the originality of the valuable instrument, and do not include information related to the substantive contents of the valuable instrument. Hence, a VPN established using a public line can be employed as the electronic network. Thus, employment of a dedicated line or the like is not essential for transmission of information, thereby reducing the cost of introducing the system. By omitting a dedicated line, the cost for establishing the network is made a variable cost, thereby enabling to reduce an initial cost incurred upon introduction of the system.

According to a second aspect of the invention, there are provided a program for having a computer serve function as the electronic clearing server according to the first aspect of the invention, and a recording medium storing the program and readable by a computer. The program may be written in any program language. The recording medium may be any recording medium currently commonly used that is capable of recording the program, e.g., CD-ROM, DVD-ROM, flexible disk, or any recording medium to be used in the future.

According to a third aspect of the invention, there is provided an electronic clearing server which manages information related to a valuable instrument including a substrate and prescribed information printed on the substrate, in order to electronically process and clear the valuable instrument. The valuable instrument further includes substrate identification information which differentiates each substrate from other substrates, and code information printed on the substrate. The server includes: an information managing portion and a validity determining portion. The information managing portion receives the substrate identification information and the code information of the valuable instrument from payor's bank terminal installed in a payor's bank which issues the valuable instrument, and manages the substrate identification information and the code information with the substrate identification information and the code information associated with each other. The validity determining portion receives the substrate identification information and the code information of the valuable instrument from a payee's bank terminal installed in a payee's bank, when the valuable instrument is presented to the payee's bank. The validity determining portion determines whether the valuable instrument as presented to the payee's bank terminal is valid, namely, whether the presented valuable instrument is an original or a replicate or duplicate, by comparing the substrate identification information and the code information as managed by the information managing portion with the substrate identification information and the code information as transmitted from the payee's bank terminal.

This electronic clearing server can operate as the electronic clearing server of the electronic clearing system according to the first aspect of the invention. Since pieces of information respectively related to a plurality of the valuable instruments can be managed in a centralized manner, it is enabled to make efficient use of the information. For instance, data mining is possible.

The connection between the electronic clearing server and the payor's bank terminal may be established by means of a VPN (Virtual Private Network). The substrate identification information and the code information include only information for warranting the originality of the valuable instrument, and do not include information related to substantive contents of the valuable instrument. Hence, a VPN established using a public line can be employed as the electronic network. Thus, a dedicated line or the like is not essential for transmission of information, thereby reducing the cost of introducing the system. By making a dedicated line inessential, the cost for establishing the network is made a variable cost, thereby reducing the initial cost incurred upon introduction of the system.

The server may further include a dishonor database for managing information on a dishonored valuable instrument, make the determination on the validity of the valuable instrument presented to the payee's bank terminal, by using the dishonor database, and add information on the presented valuable instrument to the dishonor database when the validity of the presented valuable instrument presented to the payee's bank terminal is not verified. The electronic clearing server thus arranged can manage the information on the dishonored valuable instruments in a centralized manner, thereby enabling to make efficient use of the information. For instance, data mining is possible.

According to a fourth aspect of the invention, there are provided a program for having a computer serve as the electronic clearing server according to the third aspect of the invention, and a recording medium storing the program and readable by a computer. The program may be written in any program language. The recording medium may be any recording medium currently commonly used that is capable of recording the program, e.g., CD-ROM, DVD-ROM, flexible disk, or any recording medium to be used in the future.

According to a fifth aspect of the invention, there is provided an electronic clearing terminal which electronically processes and clears a valuable instrument including a substrate and prescribed information printed on the substrate. The valuable instrument further includes code information printed on the substrate, which code information is obtained by converting substrate identification information, which differentiates each substrate from other substrates, into a specific format. The terminal includes: an information managing portion which manages the substrate identification information and the code information with the substrate identification information and the code information associated with each other; an information obtaining portion which obtains the substrate identification information and the code information from the valuable instrument as presented; and a validity determining portion which determines whether the presented valuable instrument is valid, namely, whether the presented valuable instrument is an original or a replicate or duplicate, by comparing the substrate identification information and the code information as managed by the information managing portion, with the substrate identification information and the code information as obtained by the information obtaining portion.

The fifth aspect enables an electronic clearing terminal installed in each bank to have a substantially same function as that of the electronic clearing server according to the first aspect. That is, the electronic clearing terminal installed in each bank can manage the pieces of information on a respective plurality of the valuable instruments in a centralized manner, thereby enabling to make efficient use of information unique to each bank. For instance, data mining is possible.

The features having been described above with respect to the first to fourth aspects are applicable to this electronic clearing terminal, too. That is, the substrate identification information may be information obtained from the textural pattern of the substrate, or information recorded in an IC tag that the substrate has. The specific format may be a two-dimensional barcode. That is, the code information may be obtained by converting the substrate identification information into a two-dimensional barcode, and printed on the substrate. The correspondence between the substrate identification information and the code information may be substantially one-to-one. The terminal may further include a dishonor database for managing information on a dishonored valuable instrument, make the determination on the validity of the presented valuable instrument, by using the dishonor database, and add information on the presented valuable instrument to the dishonor database when the validity of the presented valuable instrument is not verified.

According to a sixth aspect of the invention, there are provided a program for having a computer serve as the electronic clearing terminal according to the fifth aspect of the invention, and a recording medium storing the program and readable by a computer. The program may be written in any program language. The recording medium may be any recording medium currently commonly used that is capable of recording the program, e.g., CD-ROM, DVD-ROM, flexible disk, or any recording medium to be used in the future.

As described above, the invention enables to easily prevent fraudulent replication or duplication of a valuable instrument in implementing the check truncation, thereby ensuring security at low cost.

The invention enables to warrant the validity or originality of a valuable instrument simply by printing on the valuable instrument the code information obtained by converting the substrate identification information into a predetermined format. Hence, the conventional valuable instrument can be used without being greatly revised. In addition, the replacement cost, i.e., the cost of processing paper-based information, namely, converting the paper-based information into an electronic format, is considerably reduced. In this way, the check truncation can be implemented at low cost, while security is ensured even without using a dedicated line for data transmission.

Obviously, the invention can enjoy the advantageous effects of the known check truncation process. That is, the cost of the physical transportation is omitted, and the efficiency of the clearing process is enhanced as compared to the paper-based clearing process, loss of a valuable instrument such as note and check is prevented in the event of disaster, the convenience for users is enhanced, and the risk with clearance is reduced.

### BRIEF DESCRIPTION OF THE DRAWINGS

Embodiments of the present invention will be described in detail based on the following figures, wherein:

FIG. 1 shows a promissory note according to a first embodiment of the invention;

FIGS. 2A and 2B show an original and a replicate or duplicate of the promissory note, respectively;

FIG. 3 is a diagram of an electronic clearing system according to the first embodiment;

FIG. 4 is a diagram of an electronic clearinghouse server shown in FIG. 3;

FIG. 5 is a diagram of a payor's bank terminal shown in FIG. 3;

FIG. 6 is a diagram illustrating registration and verification of a substrate textural pattern ID.

FIG. 7 is a diagram of a payee's bank terminal shown in FIG. 3;

FIG. 8 is a flowchart illustrating an operation of the electronic clearing system;

FIG. 9 illustrates the operation of the electronic clearing system; and

FIG. 10 is a diagram of a bank terminal according to a second embodiment of the invention.

### DETAILED DESCRIPTION OF THE INVENTION

Hereinafter, there will be described an electronic clearing system, an electronic clearing server, an electronic clearing terminal, and a computer program according to each of embodiments of the invention, by referring to the accompanying drawings. In the present specification and the accompanying drawings, elements having a substantially same function or structure are denoted by a same reference numeral, and repetitive description is omitted. In the following description of the embodiments, a promissory note is described as a specific example of a valuable instrument.

### FIRST EMBODIMENT

There will be described a first embodiment of the invention.

First, a promissory note to which the first embodiment is applied will be described. Transactions by means of promissory notes is one of the greatest platforms to which the present embodiment is applicable, since clearances are implemented by means of promissory notes in the order of 172 million in terms of the number, and 633 trillion yen in terms of the amount, as of 2003.

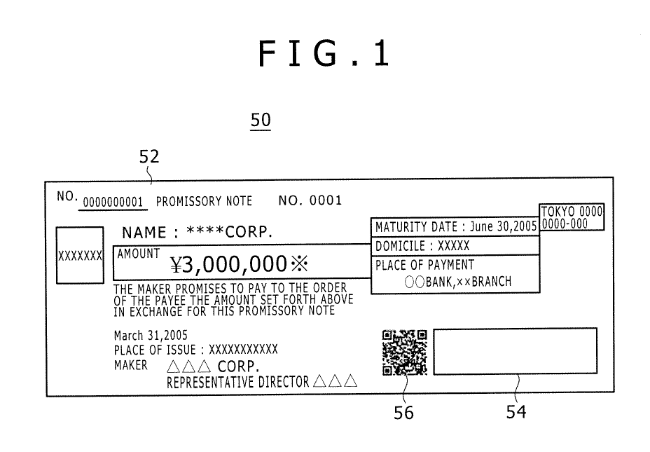

FIG. 1 shows the promissory note according to the first embodiment. The promissory note 50 is produced by printing prescribed information on a substrate that may be a common printing sheet of paper, and has a printing area 52, a textural pattern area 54, and a two-dimensional barcode 56. Substantive contents of the promissory note are printed in the printing area 52. Information that enables to discern or differentiate the substrate of each promissory note from other substrates of other promissory notes is put in the textural pattern area 54. The two-dimensional barcode 56 is obtained by converting the information obtained from the textural pattern area 54 into a predetermined format, and printed on the substrate of the promissory note. The information obtained from the textural pattern area 54 corresponds to substrate identification information, and the two-dimensional barcode 56 corresponds to code information.

In the printing area 52, the substantive contents of the promissory note are printed with a common ink that is excellent in a degree in properties such as light stability and water resistance. The substantive contents may include the name of the payee, the amount of the promissory note, the address and name of the maker, the maturity date, the domicile, and the place of payment. Although not shown, the printing area 52 may include an area in which some information is printed with a magnetic ink. Such information printed with a magnetic ink is readable by a predetermined MICR (magnetic ink character reader).

The textural pattern area 54 and the two-dimensional barcode 56 include information for warranting the validity, or the originality, of the promissory note.

The textural pattern area 54 has a rectangular shape of about 16 mm×64 mm, for instance. A transmission scanner of 200 dpi resolution extracts a feature quantity from the textural pattern area 54, thereby obtaining the substrate identification information (hereinafter referred to as “textural pattern ID”) for discerning or differentiating each substrate from other substrates.

The textural pattern ID is a predetermined feature quantity obtained from the textural pattern area 54. The textural pattern ID is information unique to each substrate. Hence, by using the textural pattern ID, a substrate can be discerned from other substrates. The feature quantity or textural pattern ID obtained from the textural pattern area 54 may be one of the following, for instance.

(a) A low-pass filter is used to extract only low frequencies of an image of the textural pattern area 54, which are used as the textural pattern ID. Such a textural pattern ID is advantageous, for instance, in terms of resistance to secular change of the substrate and printed image, and position error upon scanning of the textural pattern area 54.

(b) A shape of an area of the image of the textural pattern area 54 at which portion the frequency is high or low is used as textural pattern ID. An area where the frequency is high may be called white dot, while an area where the frequency is low may be called black dot.

(c) An image of the textural pattern area 54 is approximated into a matrix of rectangular areas, and a feature quantity is extracted from the thus approximated image, and used as the textural pattern ID.

The two-dimensional barcode 56 is information corresponding to the textural pattern ID, and obtained by encoding the textural pattern ID. The two-dimensional barcode 56 can record, and thus enables to handle, about 2000 bytes of data which may be in the form of figures and letters. Hence, even when an amount of information represented by the textural pattern ID is relatively large, the textural pattern ID can be associated with the two-dimensional barcode in one-to-one correspondence, namely, a specific textural pattern ID is associated with only a single two-dimensional barcode. However, the two-dimensional barcode 56 is merely one example of the format into which the textural pattern ID is converted, and other formats may be employed instead of the two-dimensional barcode 56. For instance, the textural pattern ID may be encoded into a one-dimensional barcode or a symbol sequence (e.g., a sequence of letters or figures), or any combination of these.

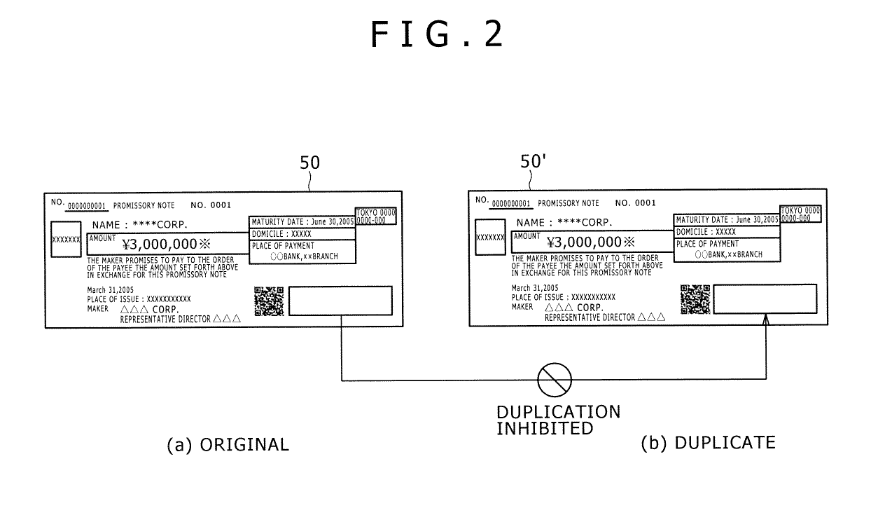

The specific example of the textural pattern ID as described above is information unique to each substrate. Hence, by using the textural pattern ID, each substrate can be discerned from other substrates. This characteristic is utilized to detect a replicate or duplicate of a promissory note, that is, when a promissory note is replicated or duplicated, the replicate or duplicate can be discerned from the original of the promissory note. When a duplicate 50′ shown in FIG. 2B is made from the original of the promissory note 50 shown in FIG. 2A, the two-dimensional barcode as well as the contents printed in the printing area 52 can be copied, but the textural pattern ID necessarily changes and cannot be copied, since the substrate of the duplicate 50′ is not identical with the substrate of the original promissory note 50. Therefore, provided that in the original promissory note the textural pattern ID and the two-dimensional barcode duly correspond to each other in the original promissory note, the textural pattern ID and the two-dimensional barcode in a duplicate do not correspond to each other. In this way, whether a promissory note is an original or a duplicate can be determined.

It is not essential that the textural pattern ID and the two-dimensional barcode correspond strictly in one-one relation. That is, it suffices that the correspondence between the textural pattern ID and the two-dimensional barcode is infinitely near one-one relation, like the case of human fingerprint or DNA, to obtain the effect of preventing fraudulent replication or duplication of promissory notes. For instance, when an amount of data that is obtained by encoding the textural pattern ID is extremely large and beyond a maximum amount that the two-dimensional barcode can handle or represent, data of the textural pattern ID may be compressed and then converted into the two-dimensional barcode, for instance.

Such data compression may be implemented using a hash function that is an irreversible, one-directional function. The hash function has a first feature that input data cannot be restored from output data, and a second feature that two hash values generated from respective data stochastically do not become identical. Hence, even when the amount of the data represented by the textural pattern ID is large and data compression is necessary, the textural pattern ID and the two-dimensional barcode can be associated with each other in substantially one-to-one correspondence. This means that the textural pattern ID may be encoded into a format that can handle or represent only an amount of data smaller than that the two-dimensional barcode represents, such as barcode and symbol sequence, e.g., sequence of letters, figures, and others.

The textural pattern ID and the two-dimensional barcode are data exclusively for ensuring the originality of the promissory note, and do not include information for other purposes. This makes the first embodiment advantageous, since information related to the substantive contents of the promissory note is not divulged, during information transfer by way of the electronic network, or when the promissory note is discarded.

There has been described a promissory note to which the first embodiment of the invention is applied. There will be next described an electronic clearing system according to the first embodiment.

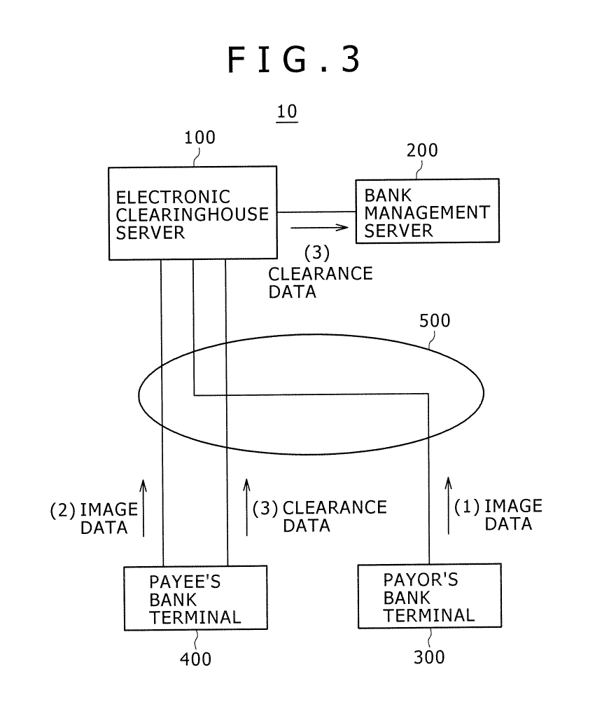

FIG. 3 is a schematic view of an electronic clearing system according to the first embodiment.

As shown in FIG. 3, an electronic clearing system 10 includes an electronic clearinghouse server 100, a bank management server 200, a payor's bank terminal 300, a payee's bank terminal 400, and an electronic network 500. The bank management server 200 manages clearing or settlement between banks, and others. The payor's bank terminal 300 is installed in a payor's bank, i.e., an issuing bank of the promissory note. The payee's bank terminal 400 is installed in a payee's bank, i.e., a bank to which the promissory note is presented. The electronic network 500 electrically connects the electronic clearinghouse server 100 with each of the payor's bank terminal 300 and the payee's bank terminal 400. The electronic clearinghouse server 100 and the bank management server 200 may be connected to each other through the electronic network 500, or other networks such as a LAN (Local Area Network) and a dedicated line.

In FIG. 3, a single payor's bank terminal 300 and a single payee's bank terminal 400 are representatively shown for simplicity of illustration. However, a plurality of the payor's bank terminals 300 and/or a plurality of the payee's bank terminals 400 may be included in the electronic clearing system 10. Actually, the system 10 may include a very large number of the payor's bank terminals 300 and payee's bank terminals 400. The payor's bank and the payee's bank are not necessarily different from each other strictly, that is, the payor's bank may serve as the payee's bank also. When the payor's bank serves as the payees' bank also, a single bank terminal having functions of both of the payor's bank terminal 300 and the payee's bank terminal 400 may be included as a constituent element of the system.

Transfer of information or data in the electronic clearing system 10 is implemented as follows. (1) The payor's bank terminal 300 sends data which includes image data of a promissory note and is generated by the payor's bank terminal 300, to the electronic clearinghouse server 100. (2) On the other hand, the payee's bank terminal 400 sends data including image data of a promissory note presented to the payee's bank, to the electronic clearinghouse server 100. (3) The payee's bank terminal 400 further sends data including data on clearance of the promissory note presented to the payee's bank, to the bank management server 200 via the electronic clearinghouse server 100. These pieces of data will be described later.

There will be now described each constituent element of the electronic clearing system 10.

(The Electronic Clearinghouse Server 100)

The electronic clearinghouse server 100 corresponds to an electronic clearing server, and stores and manages image data of promissory notes, and implements various kinds of information analysis or data mining, using the data. The electronic clearinghouse server 100 plays a central role in a clearance platform for realizing the omission of physical transportation of promissory notes, that is, the check truncation, by using image processing, authentication, and communications technologies.

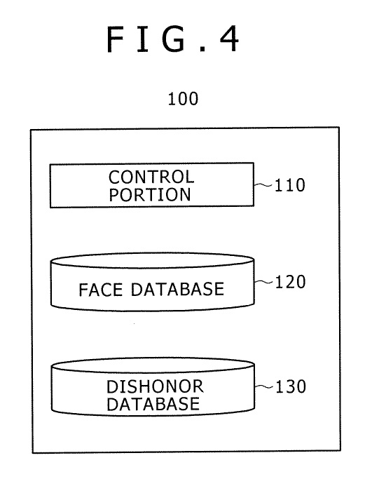

FIG. 4 is a diagram of the electronic clearinghouse server 100.

As shown in FIG. 4, the electronic clearinghouse server 100 includes a control portion 110, a face database 120, and a dishonor database 130. A part of the electronic clearing server 100 which is not directly relevant to the present embodiment is not shown nor described.

The control portion 110 is a functional part that generally controls operation of the electronic clearinghouse server 100. Further, the control portion 110 controls transfer of clearance information, between the control portion 110 and the bank management server 200 described later.

The control portion 110 also functions as a validity determining portion that determines the validity of each promissory note. That is, the control portion 110 receives, from the payee's bank terminal 400 (described later), information of the textural pattern ID and two-dimensional barcode of a promissory note presented to the payee's bank, and compares information of the textural pattern ID and two-dimensional barcode managed by the face database 120, with information of the textural pattern ID and two-dimensional barcode sent from the payee's bank terminal 400, in order to determine whether the promissory note presented to the payee's bank terminal 400 is valid, namely, whether the presented promissory note is an original or a duplicate of a promissory note.

The control portion 110 implements various kinds of data analysis processing or data mining, based on face data managed through the face database 120. The data analysis processing will be described later as examples of application of the invention.

The face database 120 corresponds to an information managing portion, and manages face data of each promissory note as sent from the payor's bank terminal 300 (described later). The face data managed through the face database 120 includes face image data, that is image data of a face, for both sides (i.e., an adverse side and a reverse side) of the promissory note, information of the two-dimensional barcode, the textural pattern ID, the name of payee, the amount of the promissory note, the address and name of the maker, the maturity date, the domicile, and the place of payment.

The face database 120 can be expanded depending on an amount of the face data handled. This makes the cost required for managing the face database 120 a variable cost, thereby reducing an initial cost incurred upon introduction of the present system 10. Such a face database 120 has a property near that of an archive file.

The dishonor database 130 manages information on a promissory note dishonored when presented to the payee's bank (described later). The information on the dishonored promissory note includes the type of dishonor, namely, information on whether the promissory note is bounced due to invalidity thereof (such a dishonor is called “dishonor under chapter two” according to the relevant Japanese law) due to fund shortage or no account in the bank of the maker (called “dishonor under chapter one” according to the same law), or due to illegitimate presentment of the promissory note such as when the promissory note contains formality deficiency (called “dishonor under chapter zero” according to the same law). The dishonor database 130 can be used to operate the “business suspension disposition system”. That is, the electronic clearinghouse server 100 can operate a system to make a disposition to suspend business for a person or a legal person that has issued a dishonored note a predetermined number of times (e.g., two times in six months), in order to ensure payment of promissory notes (or checks) circulated in the economic society. The suspension of business may be implemented such that a transaction through a current account of a bank, and a loan, are banned for a predetermined time period (e.g., two years) The dishonor database 130 can also be expanded depending on an amount of data on dishonored promissory notes handled. This makes the cost for managing the dishonor database 130 a variable cost, thereby reducing the initial cost incurred upon the introduction of the present system. The dishonor database 130 has a property near an archive file.

The electronic clearinghouse server 100 having been described above may be implemented such that a computer program for realizing the above-described functions of the electronic clearinghouse server 100 is installed in a computer to have the computer operate as the electronic clearinghouse server 100. Such a computer program may be distributed in the form of a program recorded in a predetermined recording medium (e.g., CD-ROM), or alternatively by being downloaded via an electronic network.

(The Bank Management Server 200)

The bank management server 200 is for transfer of information regarding a transaction (e.g., bank transfer) of a promissory note between the bank terminals 300, 400, and for settling the transaction. A like scheme for transferring information regarding transactions (e.g., bank transfers) of notes and checks between banks, and for settling the transactions, is referred to as domestic exchange system, and the bank management server 200 can be a server playing a central part in the domestic exchange system. A specific example of the bank management server 200 is seen in the “Data Telecommunication System of All Banks” (the Zengin System) in Japan.

It is noted, however, that inclusion of the bank management server 200 in the system 10 is not essential. That is, the electronic clearinghouse server 100 may have functions substantially the same as those of the bank management server 200, for instance.

(The Payor's Bank Terminal 300)

The payor's bank terminal 300 is a terminal installed in the payor's bank that issues the promissory note and thus may be called issuing bank. The payor's bank terminal 300 issues the promissory note including the textural pattern ID and the two-dimensional barcode, and registers the face data of the promissory note in the electronic clearinghouse server 100.

In the present embodiment, an order is placed with an external printing company for printing of a blank promissory note yet to be filled out. In this case, the printing company obtains the textural pattern ID from the substrate and converts the textural pattern ID into the two-dimensional barcode, which is then printed on the substrate. Such printing of the two-dimensional barcode does not involve a step of processing a special paper sheet or a like step, and thus can be integrated into the step of producing the blank promissory note, from a white substrate or paper sheet. The printing company further sends the textural pattern ID and information on the payor's bank that is the orderer, from a terminal installed in the printing company, to the electronic clearinghouse server 100, in order to register the textural pattern ID and the information on the payor's bank in the electronic clearinghouse server 100 with the textural pattern ID and the information on the payor's bank associated with each other.

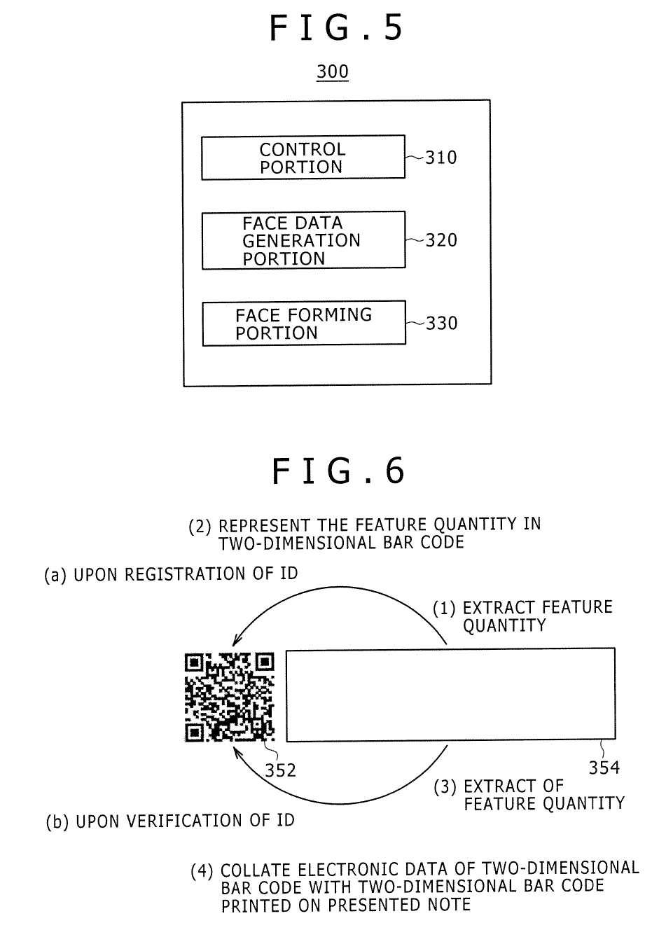

FIG. 5 is a block diagram of the payor's bank terminal 300.

As shown in FIG. 5, the payor's bank terminal 300 includes a control portion 310, a face data generating portion 320, and a face forming portion 330. Apart of the payor's bank terminal 300 which is not directly relating to the present embodiment is not shown nor described.

The control portion 310 is a functional part that generally controls operation of the payor's bank terminal 300.

The face data generating portion 320 is a functional part that generates the face data for forming the promissory note based on various kinds of information given by a customer or the maker of the promissory note (i.e., a requester who requests issuance of the promissory note).

The face data is roughly categorized into first data that is obtainable from the promissory note, and second data that is specified at the payor's bank terminal 300. The first data may include the face image data for the adverse and reverse sides of the promissory note, which image data is obtained by reading the promissory note by a scanner apparatus, the information of two-dimensional barcode (which may be referred to as two-dimensional barcode information), and the textural pattern ID. These pieces of data depend on the faces of the promissory note. On the other hand, the second data may include the name of the payee, the amount of the promissory note, the address and name of the maker, the maturity date, the domicile, and the place of payment. These pieces of data depend on the maker.

The face data generating portion 320 sends the face data to the electronic clearinghouse server 100. Among the face data, a part including the face image data for each of the adverse and reverse sides, the two-dimensional barcode information, and the textural pattern ID, is given in the form of image data, while another part including the name of the payee, the amount of the promissory note, the address and name of the maker, the maturity date, the domicile, and the place of payment, is given in the form of text data. The face data generating portion 320 converts the face data into a predetermined format, e.g., XML (eXtensible Markup Language), and sends the converted face data to the electronic clearinghouse server 100.

The thus configured face data generating portion 320 may be constituted by a scanner apparatus that reads the substrate and converts data obtained thereby into electronic data, and a computer, for instance.

The face forming portion 330 is a functional part that prints the face data on the blank promissory note based on the face data generated by the face data generating portion 320, thereby forming the promissory note. The face forming portion 330 may be constituted by a printer apparatus, for instance.

Upon completion of forming of the promissory note, the control portion 310 registers the face data in the electronic clearinghouse server 100. When the textural pattern ID is registered, the feature quantity is extracted from the textural pattern area 54, and printed in the format of the two-dimensional barcode 56, as shown in FIG. 6(a). When the textural pattern ID is to be verified by the payee's bank terminal 400 (described later), the feature quantity is extracted from the textural pattern area 54, and compared with the two-dimensional barcode 56, as shown in FIG. 6(b).

There has been described the payor's bank terminal 300.

The thus configured payor's bank terminal 300 may be constituted by a scanner apparatus that reads the substrate and converts data obtained thereby into electronic data, a printer apparatus that prints the face data on the blank promissory note, and a computer, for instance. When the payor's bank terminal 300 is constituted by the scanner apparatus, the printer apparatus, and the computer, a computer program for realizing the functions of the payor's bank terminal 300 is installed in the computer. Such a computer program may be distributed in the form of a program recorded in a predetermined recording medium (e.g., CD-ROM), or alternatively by being downloaded via an electronic network.

There has been described the case where an order is placed with an external printing company for printing of the blank promissory note. However, the present embodiment is not limited thereto, and it may be arranged such that the blank promissory note is formed or printed by the payor's bank terminal 300. When the blank promissory note is produced by the payor's bank terminal 300, the payor's bank terminal 300 obtains the textural pattern ID and converts the textural pattern ID into the two-dimensional barcode, which is printed on the substrate. It may be arranged such that the payor's bank terminal 300 associates the textural pattern ID and information of the payor's bank as the orderer, with each other, and the associated textural pattern ID and the information of the payor's bank are registered in the electronic clearinghouse server 100.

(The Payee'S Bank Terminal 400)

The payee's bank terminal 400 is a terminal installed in the payee's bank to which the promissory note is presented or submitted. The payee's bank may be also referred to as bank of first deposit or presenting bank. The payee's bank terminal 400 reads the presented promissory note on which the textural pattern ID is printed, and information obtained by the reading is sent to the electronic clearinghouse server 100, in order to verify the originality of the promissory note.

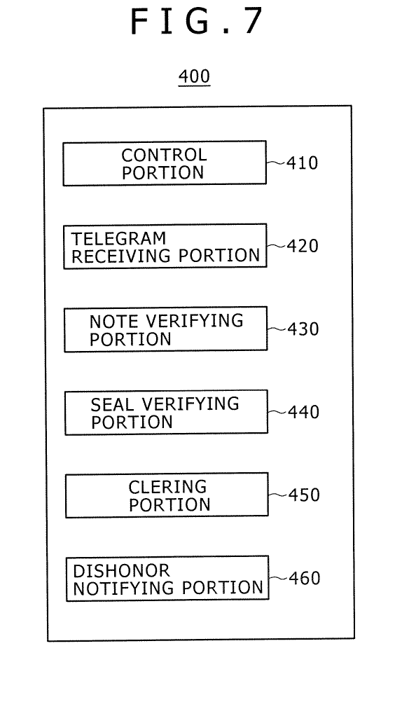

FIG. 7 is a block diagram of the payee's bank terminal 400.

As shown in FIG. 7, the payee's bank terminal 400 includes a control portion 410, a telegram receiving portion 420, a note verifying portion 430, a seal verifying portion 440, a clearing portion 450, and a dishonor notifying portion 460. A part of the payee's bank terminal not directly related to the present embodiment is not shown nor described.

The control portion 410 is a functional part that generally controls operation of the payee's bank terminal 400.

The telegram receiving portion 420 is a functional part that receives information, such as that related to the validity of a promissory note, namely, whether a promissory note is the original or not, from the control portion 110 of the electronic clearinghouse server 100.

The note verifying portion 430 is a functional part that sends predetermined information on a promissory note that is presented to the payee's bank, to the electronic clearinghouse server 100 in order to verify the validity of the promissory note, namely, determine whether the promissory note is the original or not. The note verifying portion 430 reads the presented promissory note, and obtains the textural pattern ID and the two-dimensional barcode. The textural pattern ID and the two-dimensional barcode obtained by the note verifying portion 430 are sent to the electronic clearinghouse server 100, which compares the textural pattern ID and the two-dimensional barcode as received, with the face data managed by the face database 120, thereby determining the validity of the promissory note. The electronic clearinghouse server 100 sends back, by telegram, information on the validity of the promissory note to the telegram receiving portion 420 of the payee's bank terminal 400.

The seal verifying portion 440 is a functional part that converts a seal impression on the presented promissory note into electronic data in order to implement verification thereof. That is, verification of a seal impression verification is implemented such that the electronic data of the seal impression is compared with seal impression data as registered in the electronic clearinghouse server 100. The comparison of the two pieces of seal impression data may be made by either the seal verifying portion 440 or the electronic clearinghouse server 100. Where the verification of the seal impression is implemented by the seal verifying portion 440, the electronic clearinghouse server 100 sends the seal impression data registered therein for the promissory note in question. Further, the seal verifying portion 440 may further include a monitor of a resolution of about 240 dpi, for instance, so that the comparison of the seal impression data can be made with human eyes. On the other hand, where the verification of the seal impression data is implemented by the electronic clearinghouse server 100, the seal impression data is sent to the electronic clearinghouse server 100, and the seal verifying portion 440 of the payee's bank terminal 400 receives a result of the comparison or verification from the electronic clearinghouse server 100.

The clearing portion 450 is a functional part that implements withdrawal of the amount of the promissory note to clear the promissory note when the validity of the promissory note is confirmed based on the information that is notified to the telegram receiving portion 420. Information on the clearance by withdrawal, or clearance data, is sent to the bank management server 200.

The dishonor notifying portion 460 is a functional part that notifies, when the processing of clearance or withdrawal by the clearing portion 450 is impossible, namely, when the promissory note is dishonored, information on the dishonor, to the electronic clearinghouse server 100. The electronic clearinghouse server 100 receiving the information on the dishonor manages the information on the dishonor through the dishonor database 130. In this way, the electronic clearinghouse server 100 can manage the information on dishonor of promissory notes in a centralized manner.

There has been described the payee's bank terminal 400.

The thus configured payee's bank terminal 400 may be constituted by a scanner apparatus that reads the promissory note and converts data obtained thereby into electronic data, and a computer, for instance. When the payee's bank terminal 400 is constituted by the scanner apparatus and the computer, a computer program for realizing the functions of the payee's bank terminal 400 is installed in the computer. Such a computer program may be distributed in the form of a program recorded in a predetermined recording medium (e.g., CD-ROM), or alternatively by being downloaded via an electronic network.

Although there have been described the payor's bank terminal 300 and the payees bank terminal 400, it is not essential that the payor's bank terminal 300 and the payor's bank terminal 400 are discrete terminals. Namely, a single terminal may function as both the payor's bank terminal 300 and the payor's bank terminal 400. In other words, a bank terminal (not shown) having the constituent elements of both the payor's bank terminal 300 (shown in FIG. 5) and the payee's bank terminal 400 (shown in FIG. 7) may be installed in each bank. In this way, a bank is enabled to function as both the payor's bank and the payee's bank.

(The Electronic Network 500)

The electronic network 500 electronically connects the electronic clearinghouse server 100 with each of the payor's bank terminal 300 and the payee's bank terminal 400, as shown in FIG. 3. In the present embodiment where the validity of each promissory note is ensured using the textural pattern ID, the electronic network 500 needs not be constituted by a dedicated line. The electronic network 500 may be constituted by a VPN (Virtual Private Network) established utilizing a public line, for instance. By establishing the electronic network 500 with a line that is not a dedicated line, the cost of the present system 10 is reduced and can be made a variable cost. Thus, the cost incurred by the bank or others using the present system 10 can be reduced.

The structure of the electronic clearing system 10 according to the first embodiment of the invention has been described above.

There will be now described an operation of the system 10.

(Operation of the System According to the Embodiment)

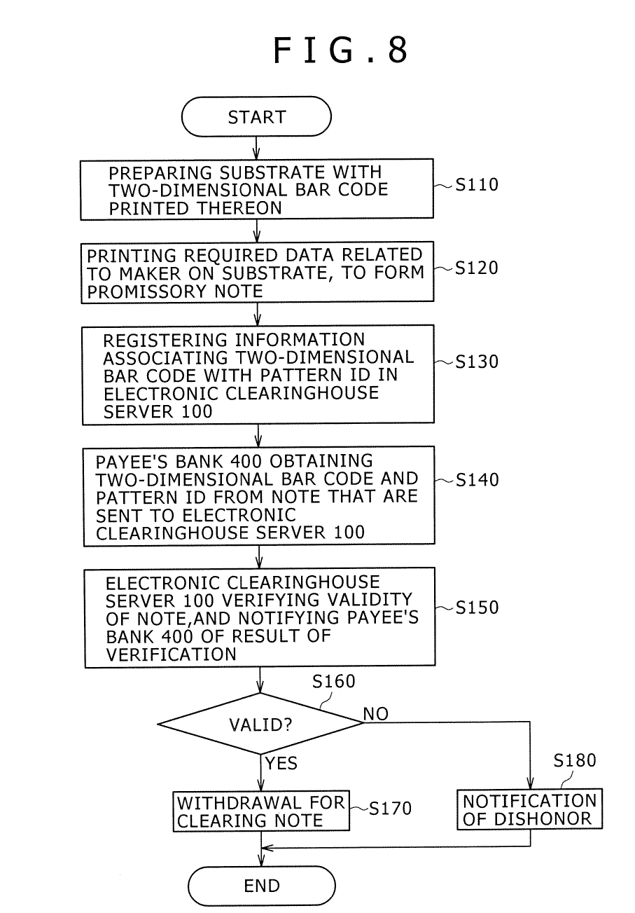

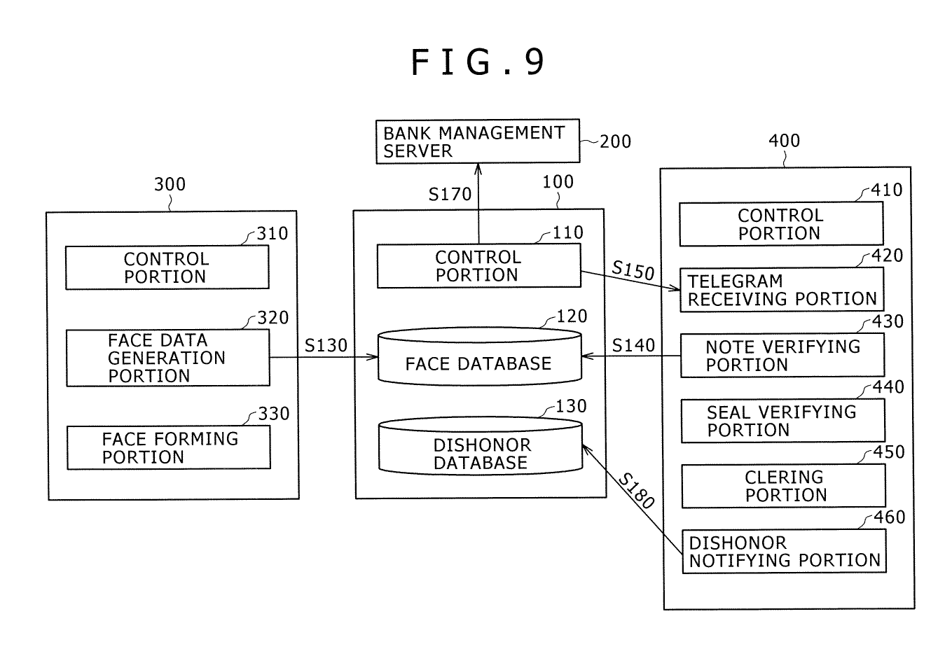

FIGS. 8 and 9 illustrate how the electronic clearing system 10 of this embodiment operates.

Data transfer between the payor's bank terminal 300 and the electronic clearinghouse server 100 is implemented by converting data into XML (extensible Markup Language) format, for instance. By combining the determination on the validity of the data itself, which determination is made using the textural pattern ID, with a scheme enabling authentication of a sender of the data (e.g., authentication using IC card or others), security of the data transfer is ensured even when the electronic network 500 is not established using a dedicated line, as described later.

<Producing the Substrate (Step S110)>

The printing company (or the payor's bank terminal 300) scans the textural pattern area (denoted by reference numeral 54 in FIG. 1) of the substrate or paper sheet, and obtains information thereon, which information is converted into the two-dimensional barcode and printed on the substrate. Employing this method enables to introduce the present clearing system 10 without changing the business practices among people using the promissory notes. Further, the conventionally used substrate is usable, and it is not necessary to specially process the substrate itself. Hence, the step of printing the two-dimensional barcode can be integrated into the step of printing, the promissory note, i.e., the step of producing the blank promissory note from the white substrate, thereby reducing the increase in the cost.

Information associating the two-dimensional barcode with the payor's bank terminal 300 is registered in the electronic clearinghouse server 100. By thus implementing a custody control before issuance of each promissory note, exchange or clearance of a promissory note is suspended or disabled in a pinpoint fashion in the event of loss or steal of the promissory note.

<Forming the Promissory Note (step S120)>

At the payor's bank terminal 300, the pieces of information on the maker of the promissory note, e.g., the account number thereof, are printed on the face of the promissory note, and the information associating the two-dimensional barcode with the maker is registered in the electronic clearinghouse server 100. By employing this method, the electronic clearinghouse server 100 can manage in a centralized manner data of the status of promissory notes. The data of the status includes the payor's bank terminal 300 which has issued the promissory note, the date on which the promissory note has been issued, and the name of the payee of the promissory note. The centralized management of the status of promissory notes enables data mining, i.e., to obtain various statistical analysis data.

After the promissory note has been formally issued by the payor's bank terminal 300 to the customer or the maker, the customer uses the promissory note when a payment for a business transaction (e.g., payment for goods) becomes due. The receiver or the payee of the promissory note presents the promissory note to the payee's bank for cashing the promissory note. As a service for the payee, it may be arranged such that the payee can verify the validity of the promissory note upon the reception of the promissory note. That is, the two-dimensional barcode and the textural pattern ID on the promissory note are read using a scanner apparatus and a computer owned by the receiver or the payee of the promissory note, and the read pieces of information are sent to the electronic clearinghouse server 100, which sends information on the validity of the promissory note by return.

<Verifying the Promissory Note (Steps S140-S180)>

Upon the presentment of the promissory note, the payee's bank reads the two-dimensional barcode and the textural pattern ID on the promissory note, and sends these pieces of information to the electronic clearinghouse server 100 (step S140). The electronic clearinghouse server 100 compares the two-dimensional barcode and the textural pattern ID as sent from the payee's bank terminal 400, with the two-dimensional barcode and the textural pattern ID as managed by the face database 120, in order to verify the validity of the promissory note, and notifies the result of the comparison or the verification to the payee's bank terminal 400 (step S150). That is, when the two sets of the two-dimensional barcode and the textural pattern ID coincide, it is determined that the validity of the promissory note is proved (step S160). In the case where an affirmative decision (YES) is made in step S160, the payee's bank implements clearance, i.e., withdrawal, for that promissory note (step S170).

In this way, it is determined that the promissory note presented to the payee's bank is identical with the promissory note as has been issued by the payor's bank, or that the substrate of the presented promissory note is identical with the substrate of the originally issued promissory note, and that the presented promissory note is not a replicate or duplicate made using a color copying machine or otherwise. According to the present embodiment, the accuracy of the determination on the authenticity of the promissory note presented to the payee's bank (i.e., whether the promissory note is an original or a replicate of an original) is high, and it is possible to easily check whether the possibility that the presented promissory note is valid is not lower than a certain level, prior to the seal impression verification.

On the other hand, when the validity of the presented promissory note cannot be proved, or when the validity of the promissory note is proved but the seal impression verification fails, that promissory note is dishonored. More specifically, the clearing portion 450 of the payee's bank terminal 400 notifies the electronic clearinghouse server 100 of the fact that the promissory note is dishonored (step S180). The electronic clearinghouse server 100 records information on the dishonored promissory note in the dishonor database 130.

The physical promissory note presented to the payee's bank is kept in trust in the payee's bank or a party entrusted thereby.

As described above, according to the present embodiment, the information of the textural pattern ID and two-dimensional barcode of the promissory note presented to the payee's bank are obtained and sent to the electronic clearing server 100, so that the validity of the promissory note, namely, the originality of the promissory note, is verifiable by the electronic clearing server 100. In this way, in implementing the check truncation, fraudulent replication or duplication of promissory notes is easily prevented. The information of the textural pattern ID and the two-dimensional barcode includes only information for warranting the originality of the promissory note, and does not include information related to the substantive contents of the promissory note. Hence, a dedicated line needs not be established for transfer of the information, thereby reducing the cost for introducing the system 10.

### Second Embodiment

There will be now described an electronic clearing system 10 according to a second embodiment of the invention. The second embodiment is an example of application of the first embodiment. That is, in the second embodiment, each bank terminal has the functions the same as those of the electronic clearinghouse server 100, in order to establish a local electronic clearing system. Namely, a bank terminal 600 is included as a constituent element of the electronic clearing system 10, in place of the payor's bank terminal 300 and the payee's bank terminal 400 both shown in FIG. 3. The other part of the electronic clearing system 10 of the second embodiment is substantially identical with that of the first embodiment shown in FIG. 3, and description thereof is omitted.

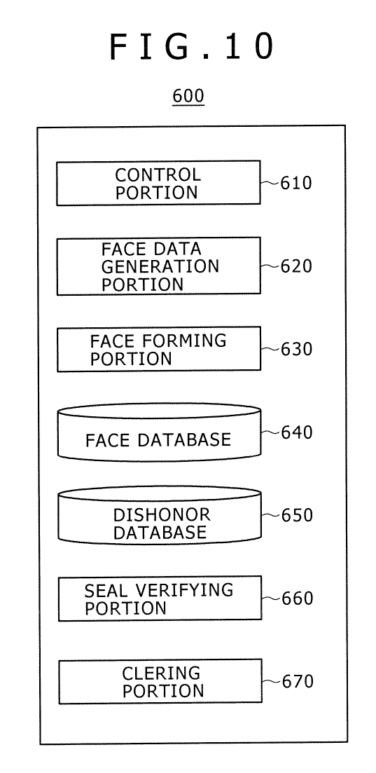

FIG. 10 is a block diagram of the bank terminal 600, which issues a promissory note and is installed in a bank to which a promissory note is presented. That is, the bank terminal 600 issues a promissory note that includes textural pattern ID and two-dimensional barcode that are identical with those in the first embodiment. When the promissory note is presented to the bank terminal 600, the bank terminal 600 scans a promissory note on which the textural pattern ID is printed, in order to verify the originality of the presented promissory note.

As shown in FIG. 10, the bank terminal 600 includes a control portion 610, a face data generating portion 620, a face forming portion 630, a face database 640, a dishonor database 650, a seal verifying portion 660, and a clearing portion 670. A part of the bank terminal 600 not directly related to the second embodiment is not shown nor described.

The control portion 610 is a functional part that generally controls operation of the bank terminal 600.

The control portion 610 serves as a validity determining portion that determines the validity of a promissory note, namely, whether a promissory note is the original or not. That is, the control portion 610 reads a promissory note presented to the bank terminal, and obtains information of the textural pattern ID and two-dimensional barcode. Then, the control portion 610 compares information of the textural pattern ID and two-dimensional barcode as managed by the face database 640, with the information of the textural pattern ID and two-dimensional barcode of the presented promissory note, and determines the validity of the promissory note presented to the bank terminal 600 (i.e., whether the promissory note is an original or a replicate of an original), based on a result of the comparison. The control portion 610 may be constituted by a scanner apparatus that reads the promissory note and converts data obtained thereby into electronic data, and a computer, for instance.

The control portion 610 implements various kinds of data analysis processing, i.e., data mining, based on the face data managed through the face database 640. The data analysis processing will be described later as examples of application of the invention.

The face data generating portion 620 and the face forming portion 630 are substantially identical with the face data generating portion 320 and the face forming portion 330 of the payor's bank terminal 300 (shown in FIG. 5) of the first embodiment. However, in the second embodiment, the face data generating portion 620 does not send the face data to the electronic clearinghouse server 100, but records the face data in the face database 640. Alternatively, the face data generating portion 620 may record the face data in the face database 640 and also send the face data to the electronic clearinghouse server 100.

The face database 640 is a database for managing the face data as generated by the face data generating portion 620. The face data managed through the face database 640 includes face image data for each of an adverse side and a reverse side of the promissory note, the information of the two-dimensional barcode information, the textural pattern ID, the name of the payee, the amount of the promissory note, the address and name of the maker, the maturity date, the domicile, and the place of payment. Thus, the face database 640 is a database especially for the bank in which the bank terminal 600 is installed, unlike the face database 120 in the first embodiment. The configuration and others of the face database 640 are substantially identical with those of the face database 120 of the electronic clearinghouse server 100 (shown in FIG. 4) in the first embodiment.

The face database 640 can be expanded depending on an amount of the face data handled. This makes the cost required for managing the face database 640 a variable cost, thereby reducing an initial cost incurred upon introduction of the present system 10. Such a face database 640 has a property near that of an archive file.

The dishonor database 650 manages information of a promissory note that is presented to the bank but dishonored. The dishonor database 650 is substantially identical with the dishonor database 130 of the electronic clearinghouse server 100 (shown in FIG. 4) according to the first embodiment. However, in contrast to the dishonor database 130 of the first embodiment which manages in a centralized manner dishonor data which is data on dishonored promissory notes as sent from a plurality of the payee's banks 400, the dishonor database 650 of the second embodiment manages data on only promissory notes as presented to and dishonored by the bank in which the bank terminal 600 is installed.

The dishonor database 650 is also expandable depending on an amount of the dishonor data handled. This makes the cost required for managing the dishonor database 650 a variable cost, thereby reducing the initial cost incurred upon the introduction of the present system 10. Such a dishonor database 650 has a property near that of an archive file.

The seal verifying portion 660 serves to convert a seal impression on the presented promissory note into electronic data in order to implement verification thereof. The seal verifying portion 660 may be constituted by a scanner apparatus that reads the substrate and converts data obtained thereby into electronic data, and a computer, for instance. The seal verifying portion 660 may further include a monitor of a resolution of about 240 dpi, so that the verification of the seal impression can be made with human eyes.

Similarly to the clearing portion 450 (shown in FIG. 7) of the fist embodiment, the clearing portion 670 is a functional part that implements withdrawal of the amount of the promissory note to clear the promissory note when the validity of the promissory note is verified by operation of the control portion 610 and the seal verifying portion 660.

According to the second embodiment, the system 10 does not include an element corresponding to the telegram receiving portion 420 of the payee's bank terminal 400 (shown in FIG. 7) in the first embodiment. The telegram receiving portion 420 of the first embodiment is an element that receives the telegram notification from the electronic clearinghouse server 100. In the second embodiment, on the other hand, there is no element corresponding to the telegram receiving portion 420, and the processing implemented by the bank terminal 600 does not involve any processing by an external element.

However, it may be modified such that an element corresponding to the telegram receiving portion 420 is incorporated in the bank terminal 600, the bank terminal 600 requests the electronic clearinghouse server 100 to verify the validity of a promissory note whose data is not included in the face database 640 and the dishonor database 650 in the bank terminal 600, and a result of the verification is sent in the form of a telegram notification to the element corresponding to the telegram receiving portion 420.

There has been described the bank terminal 600 of the second embodiment.

The thus constructed bank terminal 600 may be constituted by a printer apparatus that prints or produces a promissory note, a scanner apparatus that reads a promissory note and converts data obtained thereby into electronic data, and a computer in which a computer program for realizing the functions of the bank terminal 600 may be installed. Such a computer program may be distributed in the form of a program recorded in a predetermined recording medium (e.g., CD-ROM), or alternatively by being downloaded via an electronic network.

According to the second embodiment described above, each bank can manage inside thereof information on promissory notes in a centralized manner, and thus it is enabled to make an efficient use of the information, including data mining.

There will be described examples of application of the above-described embodiments.

### APPLICATION EXAMPLE 1

As application example 1, a service providable by the electronic clearinghouse server 100 of the first embodiment will be described.

(1) Payment Suspension Service

All promissory note clearances that involve the electronic clearinghouse server 100 are electronically controllable. Thus, when a promissory note is lost or stolen, the electronic clearing server 100 can promptly take measures such as suspension of payment for the lost or stolen promissory note.

(2) Reference Service

There can be provided a service such that the validity of a received promissory note is verified by means of the electronic clearing server 100, that is, by referencing the data (e.g., the textural pattern ID) that the electronic clearinghouse server 100 has in accumulation in a concentrated manner.

(3) Maturity Date Management Service

There can be omitted the conventional step of the payee's bank keeping in trust a presented promissory note until the maturity date comes on which date the promissory note is carried to the clearinghouse in order to clear the promissory note. That is, the electronic clearinghouse server 100 alerts the payee's bank before the maturity date of a promissory note, when the presentment of the promissory note is performed before the maturity date, thereby contributing to appropriate distribution of resources of the payee's bank.

(4) Centralized Management of Information on Dishonor

At the present time, information on dishonored promissory notes is managed by each clearinghouse independently of other clearinghouses, and not managed in a consolidated manner. That is, conventionally, when a promissory note is dishonored by a bank that is a member of a particular clearinghouse, the maker of the dishonored promissory may freely continue to make promissory notes on banks that belong to clearinghouses other than the particular clearinghouse. Employment of the electronic clearing server 100 can remedy this situation.

(5) Deployment of Services of the Electronic Clearinghouse Abroad

According to the first embodiment, information on the substrate or paper sheet is converted into electronic data that is accumulated at the electronic clearinghouse server 100, and the originality of the substrate or paper sheet of each promissory note or check is verifiable using the textural pattern ID. This enables a party to be entrusted with a note clearing service, without being bound by geographical constraints.

(6) Intermediary Services for Paper Sheets Distribution

The electronic clearinghouse server 100 can intervene between a sender and a receiver of a paper sheet in any paper sheet transfer system, in order to omit physical transportation or delivery of the paper sheet itself while warranting the validity of the original paper sheet. That is, a sender of a quotation, a voucher, a contract, or the like does not mail or physically deliver the paper sheet to a receiver, but can share the contents of the original with the receiver, by registering information on the paper sheet in the electronic clearinghouse server 100, provided that there is an advance agreement between the sender and the receiver. In this way, the scheme involving the electronic clearinghouse server 100 and the textural pattern ID enables to provide a fundamentally rationalizing service for various transfer systems based on distribution or transportation of paper sheets.

Where the second embodiment is implemented, the bank terminal 600 can provide the services that the electronic clearinghouse server 100 can provide.

### APPLICATION EXAMPLE 2

As application example 2, there will be described instances of the data mining that the electronic clearinghouse server 100 of the first embodiment can implement. That is, various data on promissory notes that have been transferred through the electronic clearinghouse server 100 can be statistically analyzed and processed. Such fine-tuned data processing services that a clearinghouse of conventional type operating based on physical transportation of paper sheets cannot provide, are made possible, and thus services to offer various kinds of information on promissory notes to a bank terminal in the present system can be provided.

(1) Analysis on Individual Company

An analysis of the status of use for a company can be made. For instance, a comparison is made among the companies in the same trade, and among the companies of the same scale, and a comparison is made among all the business partners of a company that maintain respective accounts in the same bank as the company of interest. For instance, the number of notes made, the total amount of clearings, an amount per note, and a payment cycle, of the company of interest, can be objects to be analyzed. A bank utilizes the results of the analyses for alerting relevant parties to cash crisis of a company, or for discovering the needs for operating funds, for instance. Such analyses are possible since the data are passed through the electronic clearinghouse server 100 in a centralized manner. Thus, in contrast to the situation in the past where each bank processes information by individually developing its own system, the invention enables to develop a system operable in a consolidated manner.

(2) Operation Branch Analysis

As an analysis for each operation branch, the following analyses are possible, for instance:
Feedback of information on the status of handling of notes for each branch
Feedback of information on the status of handling of notes for each region (e.g., each prefecture or each municipality)
Alerting relevant parties to the date on which a large amount of exchanges (whether credit or debit) of notes are to be made
Forecast of the date on which a large amount of exchanges are to be made, of an amount of exchanges, and of others, based on historical data

For instance, the results of the operation branch analyses can be utilized for aiding an efficient allocation of management resources of the branch such as staffs and systems.

The data or information on the status of handling of notes that can be offered includes the following:
The number of notes made (e.g., the number thereof per day, per month, and the status of making on the date on which a large amount of notes are made)
The amount of clearing (e.g., the amount per note, per day, per month, and an amount zone within which the amounts of a largest number of notes fall)
The time period related to making of note (e.g., analysis of distribution of dates of making, the date on which a large amount of notes are made, and the payment cycle, i.e., the time period from the date of making to the payment date)
   (3) Statistical Material

It is possible to offer data on clearing of notes, to public institutions (e.g., the Department of the Treasury, the Financial Services Agency, the Bank of Japan, and the Ministry of Internal Affairs and Communications) and an organization gathering statistical data.

In implementing the second embodiment, a data mining methods that the electronic clearinghouse server 100 can handle are handballed by the bank terminal 600, too.

### APPLICATION EXAMPLE 3

In the above description of the first embodiment, the information transfer among the electronic clearinghouse server 100, the payor's bank terminal 300, and the payee's bank terminal 400 has been illustrated. As an example of application of the information transfer scheme, it may be arranged such that a terminal of a person or a legal person that is a maker or a payee of a promissory note is connected to the payor's bank terminal 300 or the payee's bank terminal 400, thereby enabling information transfer therebetween. Further, it may be arranged such that a terminal of a person or a legal person that is a maker or a payee of a promissory note is connected to the electronic network 500, thereby enabling information transfer thereby. In particular, when promissory notes are to be transferred among persons or individuals, a mobile phone or other portable terminals can be utilized. The advantageous property of a paper medium, that is the browsability, is electronically realized by such terminals, which are widely used.

### APPLICATION EXAMPLE 4

The invention is applicable to various clearing methods. For instance, there is a clearing method called “point service” or the like, as a clearing method where points are fed back to a consumer depending on the amount of clearing or payment made by the consumer. The system 10 of the first embodiment can be used as a mutual funds transfer platform for the point service. That is, when the clearance processing is implemented at the bank management server 200, the points having been fed back so far to the customer in question are converted into an amount of cash, and used as cash. For instance, in a case where each company belonging to a same business group provides its own point service independently of the other companies of the same business group, the system according to the first embodiment can be employed in order to consolidate the services.

### APPLICATION EXAMPLE 5

In place of the conventional clean draft, fixed amount check, remittance check, cash registration, and other cash transfer means, a postcard can be used for cash transfer or remittance. That is, when cash is to be transmitted from a sender to a receiver, the sender purchases a postcard adapted to the system involving the textural pattern ID, and makes a remittance or sends the postcard. After receiving the postcard, the receiver presents the postcard to a post office, for instance. Once the validity of the postcard has been verified using the textural pattern ID at the post office, the receiver can receive the cash. Such an application where a paper medium, i.e., postcard, is used exhibits very high affinity with the present system.

### APPLICATION EXAMPLE 6

Similarly to the application example 5, a sender can transmit various kinds of digital contents to a receiver. For instance, it may be arranged such that by holding a postcard over a portable terminal, image data or movie data distributed by the sender (e.g., advertisement data presented by a company, and a video letter from a friend) is called up and outputted on a display of the portable terminal. Further, it may be arranged such that a postcard is held over a television apparatus or others, in place of the portable terminal, to call up image data or movie data distributed by a sender, and output the data on a display of the television apparatus. Such a service can be readily used even by a user who is not accustomed to a mobile phone or a computer.

### APPLICATION EXAMPLE 7

Application for paper transfer between companies: Omission of physical transportation of paper sheets such as quotation, bill, contract, voucher and other paper

As the business practice, it is often the case that various documents related to contracts such as quotation are issued and received in the form of paper sheets. When the issuer and the receiver of a document participate in the present system, the number of days taken to deliver the document from the issuer to the receiver, and the cost of the delivery, can be greatly reduced.

More specifically, when an issuer of a document prepares the document, the issuer scans data of the document with an ID scanner capable of handling the textural pattern, and sends the data to the server of the system where the data is stored, thus providing the same effects as those of mailing the postcard to the receiver. Upon reception of the data from the server of the system, the receiver can perform the same processing as in the case of mailing.

In this application, the business practice that the issuer issues a document in the form of a paper sheet, or the receiver receives the document in the form of a paper sheet is not forced to change, but geographical and time constraints due to physical transportation of the document are eliminated. Further, the originality of the sent document is easily and economically warranted. Hence, there can be established an inter-business infrastructure or a social infrastructure that is highly secure, compared to the conventionally seen method using facsimile communication.

The most prominent difference of the present system from the system using facsimile transfer is that the originality of the sent document is guaranteed for the receiver. In order to facilitate management of the document, a stamp stating that the document has been already scanned may be automatically printed on the original paper sheet, when the document is scanned by the scanner capable of handling the textural pattern ID. What is common to the present system and the system using facsimile transfer is that the scanner capable of handling the textural pattern ID is used as a terminal, in place of a facsimile machine. For the user, the action required in the present system is the same as that required in the conventional method using facsimile machine, i.e., to pass the document through the terminal.

### APPLICATION EXAMPLE 8

Application for public documents: Omission of physical transportation of public documents in the form of paper sheets, such as resident card, certificate of seal impression, and copy of family register

For instance, when a financial institution accepts a public document as a document for identifying a person, an original thereof in the form of a paper sheet is essentially mailed, and use of facsimile communication is principally prohibited more often than not, at the present time.

Where the textural pattern ID is employed to be included in a public document, and there is prepared a delivery spot where such a public document can be scanned, an accepter of the public document performs the same processing as in the case where the public document is received by mail, that is, confirming the contents of the transmitted data by displaying the data in the form of image, since the originality of the public document is warranted. The number of days and the cost taken by mail delivery can be greatly reduced.

### APPLICATION EXAMPLE 9

The printing or producing of the promissory note may be implemented by a customer, not by a bank.

Although conventionally a blank promissory note as printed or produced under a strict control of the bank and printing company should be used, in order to ensure security. However, by employing the textural pattern ID, the step of printing can be entrusted to a customer. When the customer prints a promissory note, the code information, ID information, and information (e.g., a password) indicative of that the customer is a customer of a bank are registered in set in the electronic clearing server, thereby making the promissory note valid. The payee of the promissory note can easily verify the authenticity of the promissory note by using a reference service offered by the electronic clearing server. In this way, a clearing scheme extremely convenient can be realized.

Although there have been described, by referring to the accompanying drawings, the electronic clearing systems, electronic clearing servers, electronic clearing terminals, and computer programs according to the embodiments of the invention, the invention is not limited to the details of the embodiments. It is to be understood that the invention may be embodied with various changes and modifications that may occur to those skilled in the art, without departing from the technical scope of the invention defined in the appended claims.

For instance, although in each of the embodiments, information (textural pattern ID) obtainable from the textural pattern of the substrate is utilized as the substrate identification information for differentiating each substrate from other substrates, the invention is not limited thereto. For instance, the substrate identification information may be information recorded in an IC tag that the substrate has. That is, any information can be utilized as the substrate identification information, as long as the information is unique to each substrate and changed when the original is replicated.

With respect to each of the embodiments, promissory note has been described as a paper medium handled in the system. However, the invention is not limited thereto, but is applicable to any kind of valuable instrument (e.g., check, stock certificate, bond, bill of landing, warehouse receipt, railway bill of landing, and coupon for goods). For instance, checks are used throughout the world in a number of 50 billion or more, and the invention is widely applicable thereto.

The present invention is applicable to an electronic clearing system, an electronic clearing server, an electronic clearing terminal, and a computer program, and particularly to an electronic clearing system, an electronic clearing server, an electronic clearing terminal, and a computer program, for implementing the check truncation. That is, the invention has an industrial applicability.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic clearing system which electronically processes and clears a valuable instrument including a substrate and prescribed information printed on the substrate, the system comprising:
an electronic clearing server;
a payor's bank terminal which is installed in a payor's bank, and originally issues the valuable instrument;
a payee's bank terminal which is installed in a payee's bank and to which the valuable instrument is presented; and
an electronic network which electronically connects the electronic clearing server with each of the payor's bank terminal and the payee's bank terminal,
wherein the valuable instrument further includes code information printed on the substrate, the code information being obtained by converting substrate identification information, which differentiates each substrate from other substrates, into a specific format,
wherein the payor's bank terminal transmits the substrate identification information and the code information to the electronic clearing server,
wherein the electronic clearing server manages the substrate identification information and the code information with the substrate identification information and the code information associated with each other,
wherein the payee's bank terminal obtains the substrate identification information and the code information from the valuable instrument presented to the payee's bank, and transmits the substrate identification information and the code information to the electronic clearing server, and
wherein the electronic clearing server determines whether the valuable instrument presented to the payee's bank terminal is valid by comparing the substrate identification information and the code information as managed by the electronic clearing server, with the substrate identification information and the code information as transmitted from the payee's bank terminal.

2. The system according to claim 1, wherein the substrate identification information is information obtained from a textural pattern of the substrate.

3. The system according to claim 1, wherein the substrate has an IC tag and the substrate identification information is recorded in the IC tag.

4. The system according to claim 1, wherein the specific format is a two-dimensional barcode.

5. The system according to claim 1, wherein the substrate identification information corresponds to the code information in one-one relation.

6. The system according to claim 1, wherein the electronic clearing server has a dishonor database for managing information on a dishonored valuable instrument, makes the determination on the validity of the valuable instrument presented to the payee's bank terminal, by using the dishonor database, and adds information on the presented valuable instrument to the dishonor database when the validity of the presented valuable instrument is not verified.

7. A computer program for having a computer function as the electronic clearing server according to any one of claims 1 to 6.

8. An electronic clearing server which manages information related to a valuable instrument including a substrate and prescribed information printed on the substrate, in order to electronically process and clear the valuable instrument, the valuable instrument further including substrate identification information which differentiates each substrate from other substrates, and code information printed on the substrate, the server comprising:
an information managing portion which receives the substrate identification information and the code information of the valuable instrument from payor's bank terminal installed in a payor's bank which issues the valuable instrument, the information managing portion managing the substrate identification information and the code information with the substrate identification information and the code information associated with each other; and
a validity determining portion which receives the substrate identification information and the code information of the valuable instrument from a payee's bank terminal installed in the payee's bank, when the valuable instrument is presented to the payee's bank, the validity determining portion determines whether the valuable instrument as presented to the payee's bank terminal is valid by comparing the substrate identification information and the code information as managed by the information managing portion, with the substrate identification information and the code information as transmitted from the payee's bank terminal.

9. The server according to claim 8, further comprising a dishonor database for managing information on a dishonored valuable instrument, and wherein the server makes the determination on the validity of the valuable instrument presented to the payee's bank terminal, by using the dishonor database, and adds information on the presented valuable instrument to the dishonor database when the validity of the presented valuable instrument is not verified.

10. A computer program for having a computer function as the electronic clearing server according to claim 8 or 9.

11. An electronic clearing terminal which electronically processes and clears a valuable instrument including a substrate and prescribed information printed on the substrate, the valuable instrument further including code information printed on the substrate, the code information being obtained by converting substrate identification information, which differentiates each substrate from other substrates, into a specific format, the terminal comprising:
an information managing portion which manages the substrate identification information and the code information with the substrate identification information and the code information associated each other;
an information obtaining portion which obtains the substrate identification information and the code information from the valuable instrument as presented; and
a validity determining portion which determines whether the presented valuable instrument is valid by comparing the substrate identification information and the code information as managed by the information managing portion, with the substrate identification information and the code information as obtained by the information obtaining portion.

12. The terminal according to claim 11, wherein the substrate identification information is obtained from a textural pattern of the substrate.

13. The terminal according to claim 11, wherein the substrate has an IC tag and the substrate identification information is recorded in the IC tag.

14. The terminal according to claim 11, wherein the specific format is a two-dimensional barcode.

15. The terminal according to claim 11, wherein the substrate identification information corresponds to the code information in one-one relation.

16. The terminal according to claim 11, further comprising a dishonor database for managing information on a dishonored valuable instrument, and wherein the terminal determines on the validity of the presented valuable instrument, by using the dishonor database, and adds information on the presented valuable instrument to the dishonor database when the validity of the presented valuable instrument is not verified.

17. A computer program for having a computer function as the electronic clearing terminal according to any one of claims 11 to 16.
